(19) United States
(12) Patent Application Publication
(10) Pub. No.: US 2005/0044181 A1
(43) Pub. Date: Feb. 24, 2005

(54) System and method for monitoring internet connections

(75) Inventor: Jae Kyung Lee, Buk-gu (KR)

Correspondence Address: FLESHNER & KIM, LLP, P.O. BOX 221200, CHANTILLY, VA, 20153, US

(73) Assignee: LG Electronics Inc.

(21) Appl. No.: 10/921,812

(22) Filed: Aug. 20, 2004

(30) Foreign Application Priority Data
Aug. 20, 2003 (KR) P2003-57570

(51) Int. Cl. G06F 15/16

(52) U.S. Cl. 709/218

(57) ABSTRACT

Disclosed is a system for protecting children or teenagers from a harmful website, the system comprises a computer configured to generating a request signal for a connection to a website, a server configured to output information of the website according to the request signal provided from the computer, and a monitoring terminal configured to receive the website information from the server, to display the website information, and to output a signal for controlling the connection to the website.

This application claims the benefit of Korean Application No. P2003-57570, filed on Aug. 20, 2003, which is hereby incorporated by reference as if fully set forth herein.

### BACKGROUND OF THE INVENTION

1. Field of the Invention

The present invention relates to a monitoring system, and more particularly, to a system and a method for monitoring an Internet connection.

2. Discussion of the Related Art

Internet is a computer network for exchanging data according to a protocol called as a TCP/IP (transmission control protocol/internet protocol). Internet services are mostly made between a client and a server. The client requests information and service and the server provides the client with the information and service requested by the client.

The service using the internet is widely used, the service including e-mail, telnet, FTP, usenet news, internet search, internet reply chat; IRC, bulletin board system; BBS, world wide web, online game, and a new service such as a service for broadcasting video or voice data in real time and a real-time meeting.

A web browser used on the Internet is a broadcasting receiver in a broadcasting field. The web browser provides information on the Internet to a user according to a request of the user. The user is easily and simply accessed to the World Wide Web by using the web browser. However, because the access to the World Wide Web is very easy, children and teenagers are also easily accessed to a harmful website. Therefore, a problem of affecting a bad influence to the children and teenagers is generated.

### SUMMARY OF THE INVENTION

Accordingly, the present invention is directed to a system and a method for monitoring an Internet connection that substantially obviates one or more problems due to limitations and disadvantages of the related art.

An object of the present invention is to provide a system suitable for monitoring an Internet connection for protecting children or teenagers from accessing to a harmful website, and a controlling method for the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a system for monitoring Internet connections includes a computer configured to generating a request signal for a connection to a website, a server configured to output information of the website according to the request signal provided from the computer, and a monitoring terminal configured to receive the website information from the server, to display the website information, and to output a signal for controlling the connection to the website.

The computer is an Internet TV, an Internet refrigerator, or a PC. The request signal includes an IP address of the website, and a phone number or an IP address of the monitoring terminal.

The server stores information of websites accessed by the computer. The server also determines, based on selected options included in the request signal, whether to provide information of all websites accessed by the computer to the monitoring terminal, or to provide information of a restricted website only to the monitoring terminal.

The website information includes at least one of a domain name or an age limit of the website.

In another aspect of the present invention, a system for monitoring Internet connections, including a computer configured to generate a request signal for a connection to a website, a server configured to determine whether the website to be accessed is a restricted website according to website information included in the request signal, and to output the website information according to a result of the determination, and a monitoring terminal configured to display the website information received from the server, and to output a signal for controlling the connection to the website.

The server determines whether the website to be accessed is the restricted website, on the grounds of a word or text included in a data stream provided from the website, or on the grounds of the pre-stored information of websites.

The server transmits the website information to the monitoring terminal when the website to be accessed is determined to be the restricted website.

A method for monitoring Internet connections, including generating a request signal for a connection to a website and transmitting the request signal from a computer to a server, transmitting website information from the server to a monitoring terminal according to the request signal, displaying the website information provided from the server by the monitoring terminal, and controlling the website connection of the computer according to a command inputted by a user through the monitoring terminal.

The transmitting the request signal from the computer to the sever comprises reading the pre-stored information of websites.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a block diagram showing a structure of a monitoring system in accordance with the present invention;

FIG. 2 illustrates a block diagram showing a structure of a display unit of the present invention;

FIG. 3 illustrates a block diagram showing a structure of a monitoring terminal of the present invention;

FIG. 4 illustrates a flow chart showing a process of selecting options related to an internet connection in accordance with the present invention;

FIGS. 5a and 5b illustrate a diagram showing a screen for selecting options related to the Internet connection;

FIG. 6 illustrates a diagram showing a process of admitting the Internet connection;

FIG. 7 illustrates a diagram showing an action of a monitoring terminal; and

FIG. 8 illustrates a diagram showing a display unit of a monitoring terminal.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

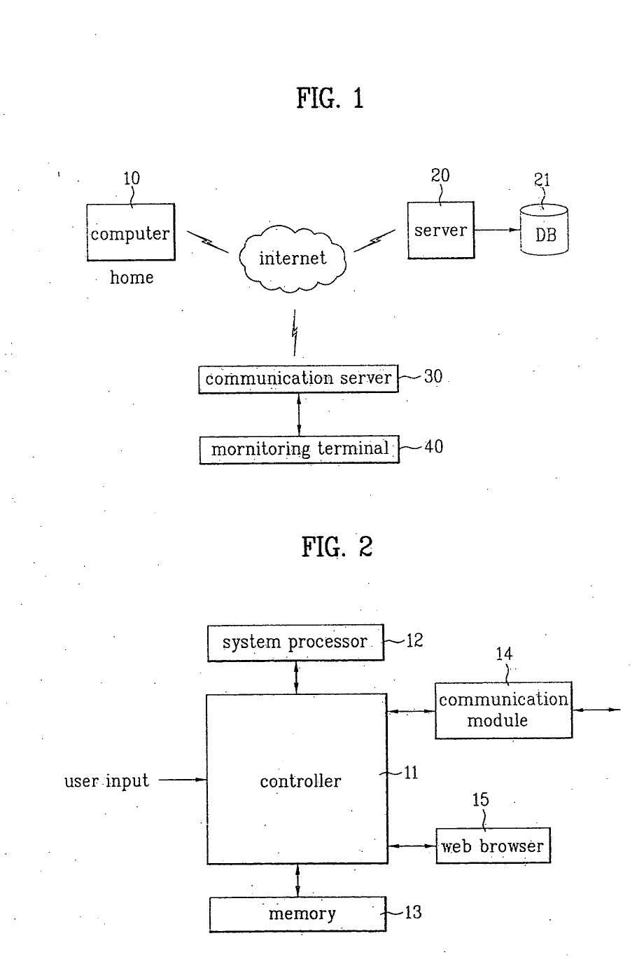

FIG. 1 illustrates a block diagram showing an example of a system for monitoring a display unit in accordance with the present invention. As illustrated in FIG. 1, the system of the present invention includes a display unit 10 enabling Internet connection, a server 20, and a monitoring terminal 40. For example, the display unit 10 may be an Internet TV, an Internet refrigerator, and a personal computer (PC). The display unit 10 provides a signal for requesting a website connection through Internet to the server 20 according to a request of a user. The server 20 determines whether the website corresponding to the connection request signal is restricted or not, and if the website is restricted, sends a message to the monitoring terminal 40 for notifying that the user attempted access to the restricted website. The server 20 includes a database 21 for storing information of a previously registered display unit. The display unit 10 is connected to a corresponding website according to a reply signal of the monitoring terminal 40 provided through Internet.

As illustrated in FIG. 2, the display unit 10 includes a controller 11, a system processor 12, a memory 13, a communication module 14, and a web browser. The controller 11 is a microprocessor for controlling a general function of the display unit 10. The controller 11 controls various actions such as an Internet search, data transmission and reception according to the request of the user inputted through a keyboard, a mouse, or a remote controller. After running a networking program, the controller 11 performs an Internet search and data transmission and reception through the communication module 14 according to a command of the user for an Internet connection, and displays researched or received data on the screen.

The system processor 12 is a main memory device including an operating system (O/S) such as Window or Unix, and various protocols are needed for Internet connection, for example, TCP/IP, PPP (Point to Point Protocol), MIME (Multi purpose Internet Mail Extension), HTTP (Hyper Text Transmission Protocol), and HTML (Hyper Text Markup Language).

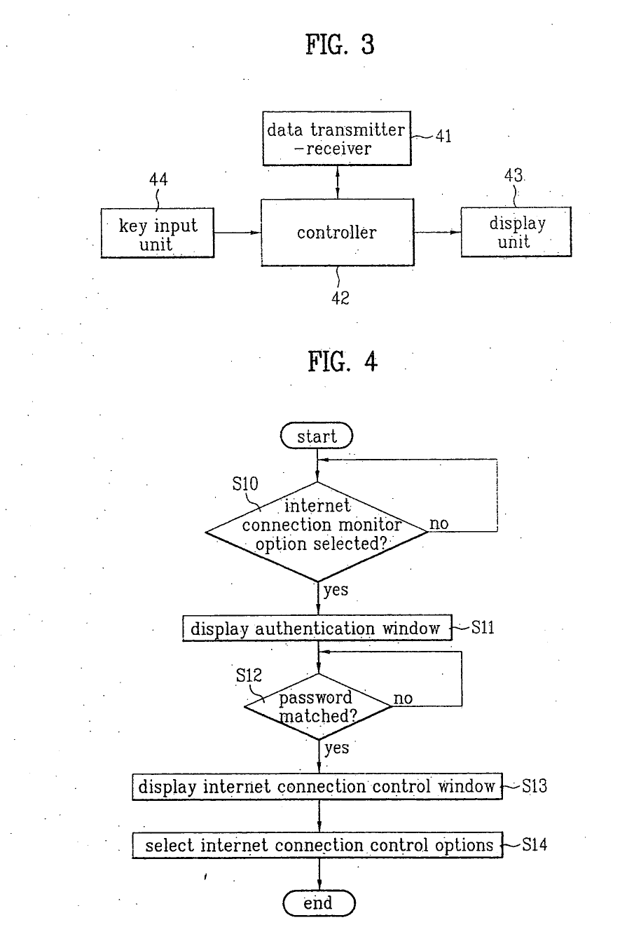

The monitoring terminal 40 is a mobile terminal such as a mobile phone and a PDA. As illustrated in FIG. 3, the monitoring terminal 40 includes a data transmitter-receiver 41 for transmitting/receiving data to/from an external device, a key input unit 44 for inputting the command of the user, a displaying member 43 for displaying data received through the data transmitter-receiver 41, or the command inputted through the key input unit 44 and a processed result corresponding to the request inputted through the key input unit 44, and a controller 42 for controlling the data transmitter-receiver 41 for transmitting and receiving data to the external device or to the display unit 10 according to the request of the user.

A method for controlling the system of the present invention is as follows. FIG. 4 illustrates a flow chart showing a process of selecting options related to an Internet connection in accordance with the present invention. First of all, the display unit 10 and a manager of the display unit (such as the parents of the user) need to be registered to the server 20. The manager goes through formalities for applying for a membership on a corresponding site of the server 20. For example, member information such as a name, an ID, a password and an address is inputted, and an IP address of the corresponding display unit 10 is entered.

When opening the membership of the manager is finished, the display unit 10 downloads a program for controlling the Internet connection from the server 20. The controller 11 of the display unit 10 stores the downloaded program and URL (Uniform Resource Locator) information of the server 20 in the memory 13.

The manager installs the Internet-connection controlling program to the display unit 10. The display unit 10 determines whether the manager is a member previously registered on the server when the manager is accessed to a “set menu” provided by the controlling program. For example, the display unit 10 displays a password input screen (S11) so as to compare the password inputted by the manager with the password on the server 20 (S12).

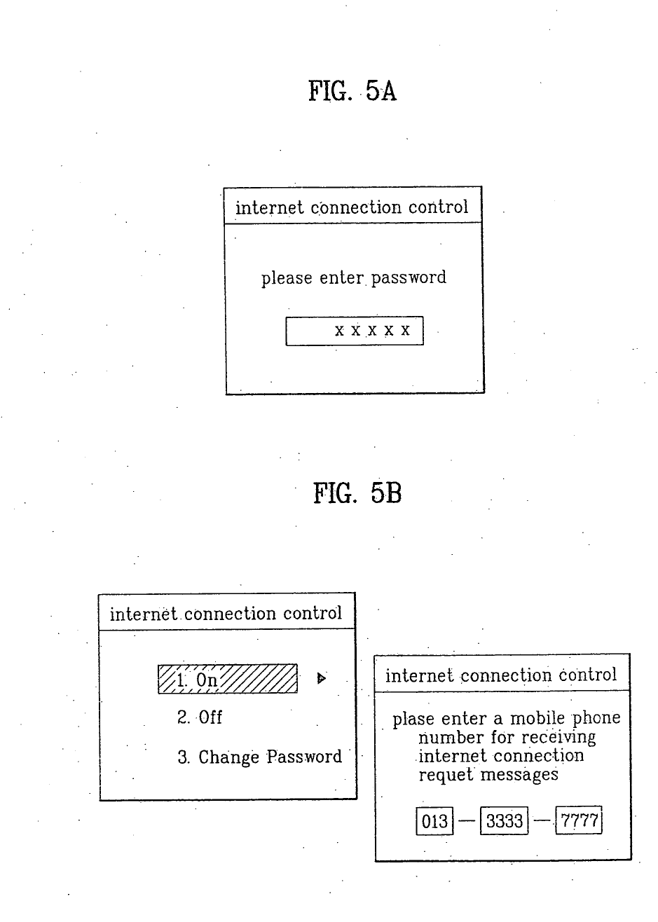

If the manager is a registered member, the display unit 10 displays the set menu on the screen as illustrated in FIG. 5 (S13). The manager selects/sets (S14) options related to the Internet connection and monitoring by using the set menu. For example, the manager can select a function of the server 20 for transmitting information of the suite to the monitoring terminal only when a user is accessed to an adult site, an obscene site, a violent site and a suicidal site, or can select a function of the server 20 for transmitting information of all sites accessed by the user in real time. In addition, the manager inputs the phone number or the IP address of the monitoring terminal 40 by using the set menu, and stores in the memory 13. The manager is able to access to the set menu through a password input process and to set on or off the function of controlling the Internet connection of the display unit 10 by using the set menu.

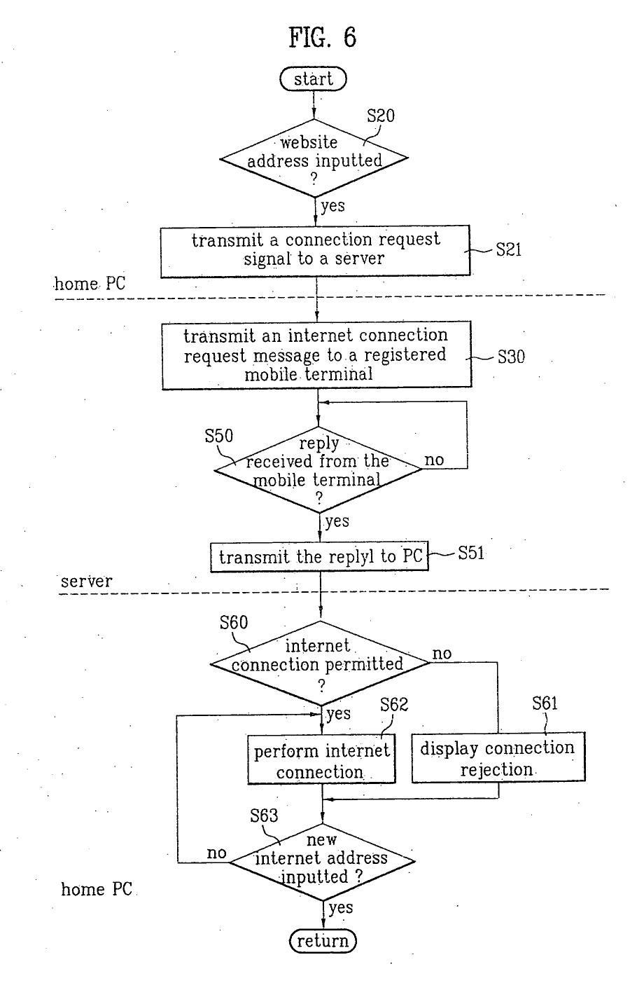

FIG. 6 illustrates a diagram showing a process of admitting Internet connection. After the manager selects/sets the options, if the user inputs (S20) the IP address or a domain name of the website for an access to a particular website, the display unit 10, on the grounds of URL information stored in the memory 13, is automatically connected to the server 20, and a connection request signal is transmitted (S21) to the server 20, the connection request signal including the address or the domain name of the inputted website, the selected option information, and the phone number of the monitoring terminal 40. The controller 11 of the display unit 10 reads the option information from the memory 13 and provides the information to the server 20.

The server 20 confirms the option information provided from the display unit 10 and transmits the data to the monitoring terminal 40 according to the option information. For example, according to the option information, the server 20 transmits a connection request message along with the information of all websites to which the user wants to access, or the restricted website information and the connection request message, only when the user tries to access to the restricted website, to the monitoring terminal 40.

Only if the restricted website is monitored, the server 20 determines whether the website accessed by the user is restricted, or determines a corresponding age limit on the website. The server 20, based on the domain name, or based on a text or word included in a stream provided from the website, determines whether the website accessed by the user is the restricted website. If a restricted text or word is included in the domain name or the stream, the server 20 determines the website as a restricted site. The server 20, based on the information of the websites stored in the DB 21, may also determine whether the website accessed by the user is restricted. The DB 21 stores fields of contents provided by the websites and information related to obscenity and harmfulness of the websites. When the website accessed by the user is the restricted website, the server 20 transmits a message together with the telephone number of the monitoring terminal 40 to a server 30 of a communication server, the message for notifying tat the user tries to access to the restricted website, and transmits related website information to the communication server 30. The related website information may include the age limit. The communication server 30 then transmits (S30) the received message to the monitoring terminal 40 corresponding to the received phone number.

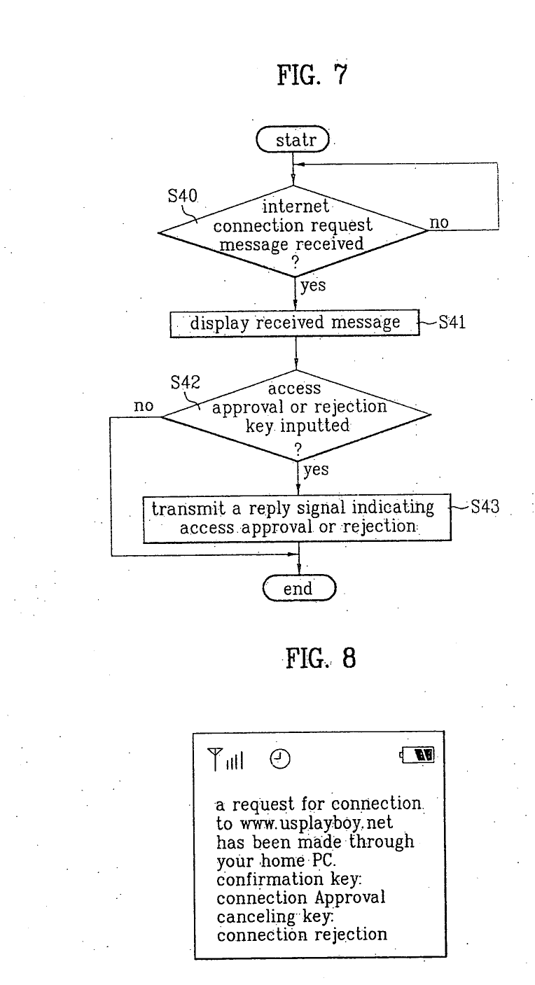

FIG. 7 illustrates a diagram showing an action of the monitoring terminal 40. As illustrated in FIG. 7, the monitoring terminal 40 receives (S40) the website information and the connection request message from the server 20. The monitoring terminal 40 then displays (S41) the connection request message to the display unit 43. In this instance, the website domain name is displayed together with the connection request message. For example, as illustrated in FIG. 8, the monitoring terminal 40 displays the message, “The PC is trying to access to http://usplayboy.net.” The monitoring terminal 40 includes a button for approving the connection and a button for rejecting the connection. When the manager wants detailed information of the website, the monitoring terminal 40 may provide related website information received from the server 20 to the manager. The related website information includes a field of contents provided by the website, and information related to obscenity and harmfulness of the website.

When the manager selects (S42) “Rejection” for rejecting the display unit 10 from being connected to http://usplayboy.net, the monitoring terminal 40 transmits (S43) a “Rejection” response of the manager to the server 20. Referring to FIG. 6, the server 20 receivers (S50) a response signal of the manager from the monitoring terminal 30, and transmits (S51) the received response signal to the display unit 10.

The display unit 10 understands (S60) the response signal through the server 20. If the response of the manager is “Approval,” the display unit 10 is connected (S62) to the website. Contrary to above, if the response of the manager is “Rejection,” the display unit 10 displays (S61) a message notifying that the connection request is rejected. When the user inputs another website address to the display unit 10, the process aforementioned is repeated.

As mentioned above, the system in accordance with the present invention enables the parents or the manager to monitor the internet use of children because the information of the website desired to be accessed is provided to the monitoring terminal 40 of parents or a manager. Moreover, the children are protected from being accessed to a harmful website because the parents or the manager determines whether the children are connected to the Internet.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A system for monitoring Internet connections, the system comprising:
a computer configured to generating a request signal for a connection to a website;
a server configured to output information of the website according to the request signal provided from the computer; and
a monitoring terminal configured to receive the website information from the server, to display the website information, and to output a signal for controlling the connection to the website.

2. The system of claim 1, wherein the computer comprises any one of an Internet (television) TV receiver, an Internet refrigerator, and a personal computer (PC).

3. The system of claim 1, wherein the request signal comprises an internet protocol (IP) address of the website.

4. The system of claim 1, wherein the request signal comprises a phone number or an internet protocol (IP) address of the monitoring terminal.

5. The system of claim 1, wherein the server is configured to store the website information in a memory.

6. The system of claim 1, wherein the server is configured to determine, based on selected options included in the request signal, whether to provide information of all websites accessed by the computer or to provide information of a restricted website only, to the monitoring terminal.

7. The system of claim 1, wherein the website information comprises a domain name of the website.

8. The system of claim 1, wherein the website information comprises an age limit of the website.

9. A system for monitoring Internet connections, the system comprising:
a computer configured to generate a request signal for a connection to a website;
a server configured to determine whether the website to be accessed is a restricted website according to website information included in the request signal, and to output the website information according to a result of the determination; and
a monitoring terminal configured to display the website information received from the server, and to output a signal for controlling the connection to the website.

10. The system of claim 9, wherein the server, based on contents of the website, is configured to determine whether the website to be accessed is the restricted website.

11. The system of claim 9, wherein the server, based on pre-stored information of pre-selected list of websites, determines whether the website to be accessed is the restricted website.

12. The system of claim 9, wherein the website information comprises an age limit of the website.

13. The system of claim 9, wherein the server is configured to transmit the website information to the monitoring terminal when the website to be accessed is determined to be the restricted website.

14. A method for monitoring Internet connections, comprising the steps of:
generating a request signal for a connection to a website and transmitting the request signal from a computer to a server;
transmitting website information from the server to a monitoring terminal according to the request signal;
displaying the website information provided from the server by the monitoring terminal; and
controlling the website connection of the computer according to a command inputted by a user through the monitoring terminal.

15. The method of claim 14, wherein the request signal comprises an internet protocol (IP) address of the website.

16. The method of claim 14, wherein the request signal comprises a phone number or an IP address of the monitoring terminal.

17. The method of claim 14, wherein the website information comprises a domain name of the website.

18. The method of claim 14, wherein the website information comprises an age limit of the website.

19. The method of claim 14, wherein the method further comprises extracting the website information from data stream provided by the website.

20. The method of claim 14, wherein the transmitting the website information from the server to the monitoring terminal comprises reading the pre-stored information of pre-selected list of websites from the server.

21. A method for monitoring Internet connections, comprising:
transmitting a request signal for a connection to a website from a computer to a server;
determining whether the website to be accessed is a restricted website according to the request signal;
transmitting the website information from the server to a monitoring terminal according to a result of the determination;
displaying the website information provided from the server by the monitoring terminal; and
controlling the website connection of the computer according to a user command inputted throgh the monitoring terminal.

22. The method of claim 21, wherein the determining whether the website to be accessed is the restricted website comprises determining, based on contents of the website, whether the website to be accessed is the restricted website.

23. The method of claim 21, wherein the determining whether the website to be accessed is a restricted website comprises determining, based on the pre-stored information of pre-selected list of websites, whether the website to be accessed is the restricted website.
